(19) United States
(12) Patent Application Publication
(10) Pub. No.: US 2013/0307901 A1
(43) Pub. Date: Nov. 21, 2013

(54) MECHANISM FOR WIPING INK EJECTION SURFACE OF RECORDING HEAD

(71) Applicant: Kyocera Document Solutions Inc., Osaka (JP)

(72) Inventor: So Takahashi, Osaka (JP)

(21) Appl. No.: 13/898,054

(22) Filed: May 20, 2013

(30) Foreign Application Priority Data
May 21, 2012 (JP) 2012-115872

(51) Int. Cl. B41J 2/165

(52) U.S. Cl. CPC B41J 2/16544
USPC 347/33

(57) ABSTRACT

The wiping mechanism of a recording head has a wiper and driving mechanism. The driving mechanism moves the wiper bidirectionally along an ink ejection surface and raises and lowers the wiper toward and away from the ink ejection surface. After the top of the wiper passes through a nozzle area, which is part of the ink ejection surface, on which the ejection nozzles are open, and before the top of the wiper passes through the edge of the ink ejection surface on the downstream side in the wiping direction, the driving mechanism moves the wiper away from the ink ejection surface with the top of the wiper in contact with the ink ejection surface.

### INCORPORATION BY REFERENCE

This application is based upon, and claims the benefit of priority from, corresponding Japanese Patent Application No. 2012-115872 filed in the Japan Patent Office on May 21, 2012, the entire contents of which are incorporated herein by reference.

### BACKGROUND

Unless otherwise indicated herein, the description in this section is not prior art to the claims in this application and is not admitted to be prior art by inclusion in this section.

Facsimile machines, copiers, printers, and other recording apparatuses are designed so that an image is recorded on paper, an overhead projector (OHP) sheet, or another recording medium. Recording apparatuses can be classified into, for example, inkjet types, wire dot types, thermal types, and the like according to the recording method. Inkjet recording methods include, for example, serial types and line head types. In one inkjet recording method of serial type, recording is performed while, for example, the recording head scans a recording medium. In one inkjet printing method of line head type, recording is performed by, for example, a single-path (one-path) method. As for an inkjet recording apparatus that uses inkjet recording method of line head type, recording heads arranged in a line are secured to, for example, the main body.

An inkjet recording apparatus of line head type includes inkjet heads of line head type (recording heads), at least one for, for example, each color, on which ejection nozzles are aligned at intervals of a prescribed spacing over, for example, an entire printing area width of a printing area, the printing area width being orthogonal to a direction in which recording media are transported. When ink is ejected from the ejection nozzles corresponding to print positions conforming to the transportation of the recording medium, printing is performed over the entire recording medium.

Inkjet recording apparatuses of this type are generally problematic in that the ink ejection nozzle, which has an opening in the ink ejection surface of the recording head, may cause ink in the nozzle to be dried or may be clogged. To suppress ink in the ink ejection nozzle from being dried or the nozzle from being clogged, after ink has been ejected from the nozzle, ink adhering to the ink ejection surface (nozzle surface) is wiped off with, for example, a blade-like wiper so that the recording head is restored. The wiper is formed with, for example, a rubber blade or another elastic material. When the wiper is pressed against the ink ejection surface by being elastically deformed, ink can be wiped off while the wiper is brought into tight contact with the ink ejection surface so as not to leave a clearance between the wiper and the ink ejection surface.

In the structure described above, it is preferable, for example, to continue the wiping operation by a wiper to an end of the ink ejection surface to prevent ink residual, paper chips, or other foreign matter from being left on the ink ejection surface. Upon completion of the wiping operation, the wiper is moved away from the ink ejection surface to a wiping start position without contacting the ink ejection surface, making the wiper ready for a next wiping operation.

If ink is wiped off to the end of the ink ejection surface while the wiper is pressed against the ink ejection surface, however, when the top of the wiper to which ink droplets adhere passes through the end of the ink ejection surface, the wiper, which has been warped by being elastically deformed, may be rapidly restored to its original shape due to its restoring force. If this happens, an ink droplet that is adhering to the top of the wiper may bounce off and may scatter, contaminating the interior of the inkjet recording apparatus.

In view of the above situation, many methods of suppressing an ink droplet from scattering from the wiper are proposed.

For example, an inkjet apparatus is proposed in which a wiping support member made of a flexible material is used so that the wiping support member is twisted when a wiping member slides on a nozzle surface. This may cause the deformed wiping member to be gradually restored to its original state. A recording apparatus is also proposed in which a sloped member is provided along which a wiper blade is guided so as to move away from a string of nozzles. This may cause a warped wiper blade to be gradually restored.

An inkjet recording apparatus is also proposed in which a wiper is moved in a wiping direction, from one end of the ink ejection surface toward another end, and the wiper is moved away from the ink ejection surface at a change position at which the ability to have ink adhere to the wiper is changed so as to be increased; the change position being between the other end and the opening of a nozzle closest to the other end.

### SUMMARY

A wiping mechanism of a recording head in an embodiment of the present disclosure includes a wiper and a driving mechanism. The wiper may be configured to wipe an ink ejection surface of the recording head in a prescribed wiping direction, the recording head having ejection nozzles from which to eject ink. The driving mechanism may be configured to move the wiper bidirectionally along the ink ejection surface and raise and lower the wiper in a direction toward and a direction away from the ink ejection surface. After the top of the wiper passes through a nozzle area, which is part of the ink ejection surface, on which the ejection nozzles are open, and before the top of the wiper passes through the edge of the ink ejection surface on the downstream side in the wiping direction, the driving mechanism may be configured to move the wiper away from the ink ejection surface with the top of the wiper in contact with the ink ejection surface so that, in comparison of a first amount of warp with a second amount of warp, the second amount of warp is kept smaller than the first amount of warp; the first amount of warp is an amount by which the wiper is warped in a direction in which the wiper moves when the top of the wiper passes through the nozzle area, and the second amount of warp is an amount by which the wiper is warped when the top of the wiper passes through the edge on the downstream side of the ink ejection surface.

In another embodiment of the present disclosure, an inkjet recording apparatus is provided that includes a wiping mechanism having the above structure and a recording head.

In a still further embodiment of the present disclosure, a recording head wiping method is provided wherein the ink ejection surface is wiped in a prescribed wiping direction by using a driving mechanism having the above structure to move a wiper bidirectionally having the above structure along the ink ejection surface and to raise and lower the wiper in a direction toward and a direction away from the ink ejection surface. After the top of the wiper passes through the nozzle area and before the top of the wiper passes through the edge of the ink ejection surface on the downstream side in the wiping direction, the driving mechanism may be configured to move the wiper away from the ink ejection surface with the top of the wiper in contact with the ink ejection surface so that, in comparison of a first amount of warp with a second amount of warp, the second amount of warp is kept smaller than the first amount of warp; the first amount of warp is an amount by which the wiper is warped in a direction in which the wiper moves when the top of the wiper passes through the nozzle area, and the second amount of warp is an amount by which the wiper is warped when the top of the wiper passes through the edge on the downstream side of the ink ejection surface.

Additional features and advantages are described herein, and will be apparent from the following Detailed Description and the figures.

### BRIEF DESCRIPTION OF THE FIGURES

In the accompanying drawings:

FIG. 1 is a side view that schematically illustrates the general structure of an inkjet recording apparatus in an embodiment of the present disclosure;

FIG. 2 is a plan view of a first transport unit and a recording unit included in the inkjet recording apparatus illustrated in FIG. 1 when viewed from above;

FIG. 3 is a perspective view of the recording unit when viewed from above;

FIG. 4 is a side view of recording heads that form a line head included in the recording unit;

FIG. 5 is a plan view of the recording heads when viewed from an ink ejection surface;

FIG. 6 schematically illustrates an ink flow path in the inkjet recording apparatus in the embodiment of the present disclosure—the ink flow path extends from an ink tank to the recording heads;

FIG. 7 is a perspective view of a wiping mechanism, mounted in a maintenance unit, in an embodiment of the present disclosure when viewed from above at an angle.

FIG. 8 is a perspective view of a carriage, which is part of the wiping mechanism in an embodiment, when viewed from above at an angle;

FIG. 9 is a perspective view of a support frame, which is part of the wiping mechanism in an embodiment, when viewed from above at an angle;

FIG. 10 is an external perspective view of a unit case of the maintenance unit with the wiping mechanism removed;

FIG. 11 is a perspective view of a raising-and-lowering mechanism provided in the unit case with lift members placed horizontally;

FIG. 12 is a perspective view of the raising-and-lowering mechanism located in the unit case with the lift members extended from the position illustrated in FIG. 11;

FIG. 13 is a perspective view of the lift member, which is part of the raising-and-lowering mechanism;

FIG. 14 is a side view illustrating when the maintenance unit is placed below the recording unit;

FIG. 15 is a side view of the carriage, wipers, support frame, and raising-and-lowering mechanism, which are included in the maintenance unit, in the position illustrated in FIG. 14;

FIG. 16 is a side view illustrating when the support frame and carriage has been raised by the raising-and-lowering mechanism from the position illustrated in FIG. 15 and the wipers are brought into pressure contact with the ink ejection surface;

FIG. 17 is a side view illustrating when the carriage has moved from the position illustrated in FIG. 16 in a wiping direction, which is indicated by the arrow A;

FIG. 18 is a side view illustrating when the support frame and carriage have been lowered by the raising-and-lowering mechanism from the position illustrated in FIG. 17 and the wipers have been separated from the ink ejection surface;

FIG. 19 is a side view illustrating when the carriage has moved from the position illustrated in FIG. 18 in a direction, opposite to the wiping direction, that is indicated by the arrow A′;

FIG. 20 is an enlarged view illustrating a position at which a wiper, which is part of the wiping mechanism in the first embodiment, is stopping in the position illustrated in FIG. 17, in which the carriage has moved in the wiping direction indicated by the arrow A;

FIG. 21 is an enlarged view illustrating when a wiper is being separated from the ink ejection surface;

FIG. 22 is an enlarged view illustrating when the wiper in FIG. 21 has been completely separated from the ink ejection surface;

FIG. 23 is an enlarged view illustrating when a wiper, which is part of the wiping mechanism in an embodiment of the present disclosure, is moving in the wiping direction; and

FIG. 24 is an enlarged view illustrating when the wiper in FIG. 23 has moved to the edge of the recording head.

### DETAILED DESCRIPTION

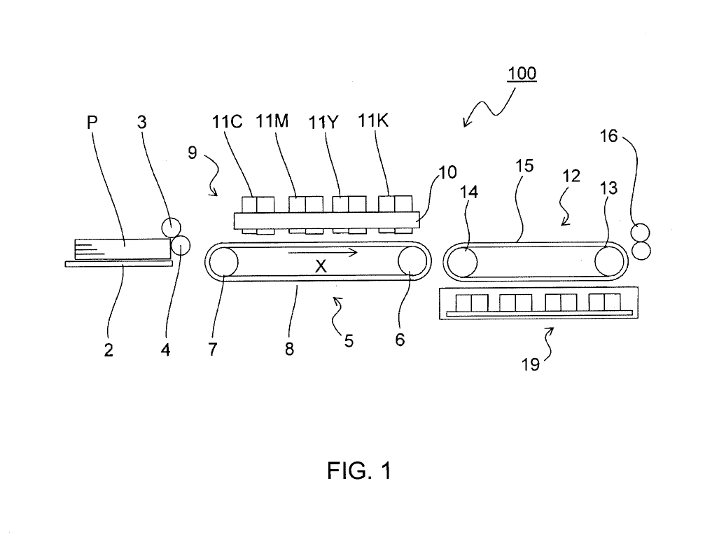

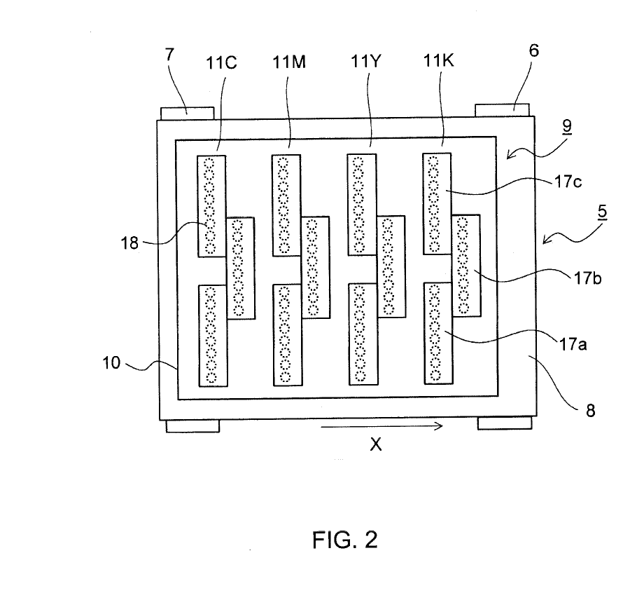

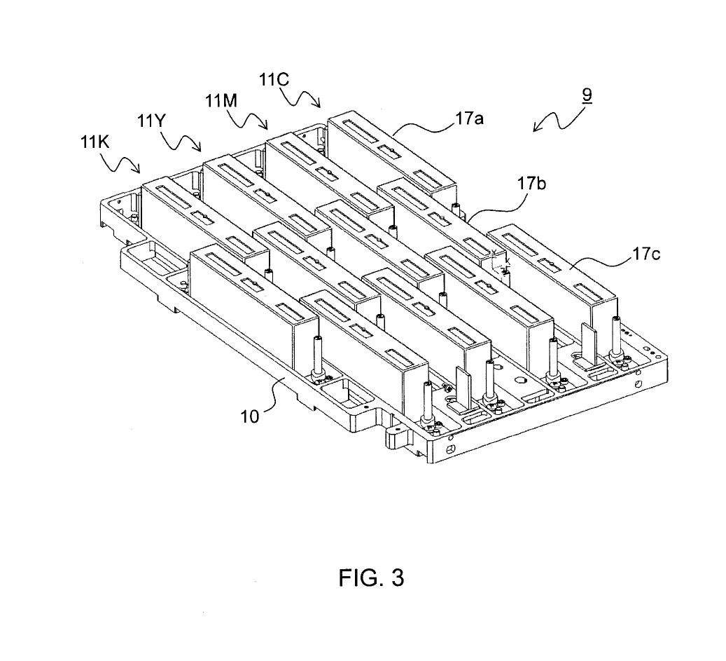

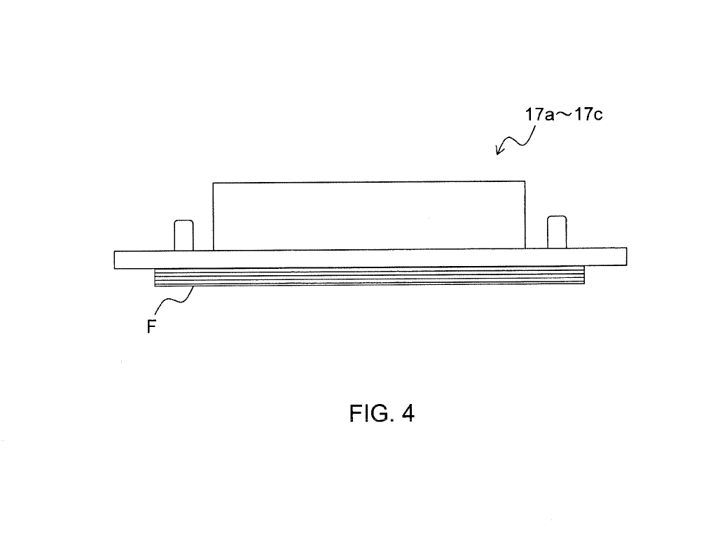

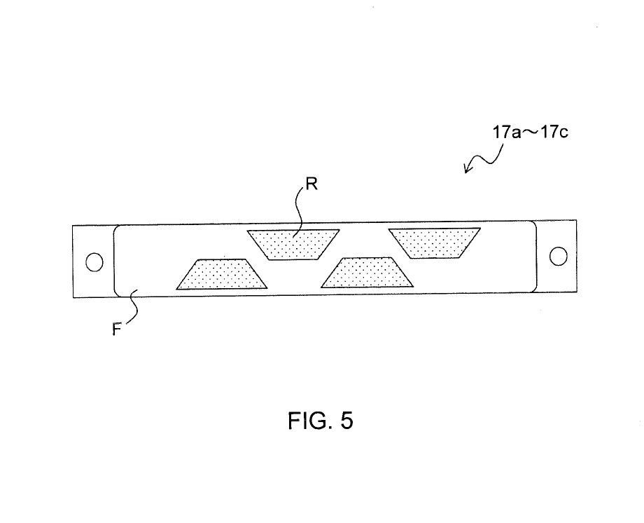

Embodiments of the present disclosure will be described with reference to the drawings. FIG. 1 is a side view that schematically illustrates the general structure of an inkjet recording apparatus 100 in an embodiment of the present disclosure. FIG. 2 is a plan view of a first transport unit 5 and a recording unit 9 included in the inkjet recording apparatus 100 illustrated in FIG. 1 when viewed from above. FIG. 3 is a perspective view of the recording unit 9 when viewed from above at an angle. FIG. 4 is a side view of recording heads 17a to 17c that form one of line heads 11C, 11M, 11Y, and 11K included in the recording unit 9. FIG. 5 is a plan view of the recording heads 17a to 17c when viewed from an ink ejection surface F. FIG. 3 illustrates when the recording unit 9 is viewed from the back in FIG. 1 (above in FIG. 2). The alignment of the line heads 11C, 11M, 11Y, and 11K in FIG. 3 is opposite to that in FIGS. 1 and 2. The recording heads 17a to 17c have the same structure. Therefore, in FIGS. 4 and 5, the recording heads 17a to 17c are illustrated in a single drawing.

As illustrated in FIG. 1, a paper feed tray 2, in which paper sheets P are stacked, is located on the left side of the inkjet recording apparatus 100. A paper feed roller 3 and a driven roller 4 are located at one end of the paper feed tray 2. The paper feed roller 3 sequentially transports paper sheets P to a first transport unit 5 described later, a sheet at a time, starting from the topmost paper P. The driven roller 4 is brought into pressure contact with the paper feed roller 3 and is rotationally driven thereby.

The first transport unit 5 and recording unit 9 are located downstream (on the right side in FIG. 1) of the paper feed roller 3 and driven roller 4 in the paper transport direction indicated by the arrow X in FIG. 1. The first transport unit 5 includes a first drive roller 6 positioned at the downstream end in the paper transport direction, a first driven roller 7 positioned at the upstream end, and a first transport belt 8 tensioned between the first drive roller 6 and the first driven roller 7. When the first drive roller 6 rotates clockwise, the paper P held by the first transport belt 8 is fed in the direction indicated by the arrow X.

Since the first drive roller 6 is positioned at the downstream end in the paper transport direction, a force is applied to the transport surface (upper-side surface in FIG. 1) of the first transport belt 8 in the direction in which the first transport belt 8 is pulled by the first drive roller 6. Thus, the tension of the transport surface of the first transport belt 8 increases, enabling the paper P to be stably transported. A dielectric resin sheet is used to form the first transport belt 8. A seamless belt having no joints is mainly used as the first transport belt 8.

The recording unit 9 includes line heads 11C, 11M, 11Y, and 11K. The line heads 11C, 11M, 11Y, and 11K may be held in, for example, a head housing 10. These line heads 11C, 11M, 11Y, and 11K are supported at a height so as to form a prescribed spacing (1 mm, for example) above the transport surface of the first transport belt 8. As illustrated in FIG. 2, a plurality of recoding heads 17a to 17c (three recording heads in FIG. 2) are placed in a staggered arrangement along the paper width direction (vertical direction in FIG. 2) orthogonal to the paper transport direction. The line heads 11C, 11M, 11Y, and 11K cover a recording area that is wider than the width of the paper P to be transported. Therefore, they can eject inks from ink ejection nozzles 18 corresponding to print positions toward the paper P transported on the first transport belt 8.

As illustrated in FIGS. 4 and 5, nozzle areas R, in each of which many ink ejection nozzles 18 are arranged, are allocated on the ink ejection surface F of each of the recording heads 17a to 17c. As illustrated in FIGS. 2 and 3, the ends of the three recording heads 17a to 17c, constituting one of the line heads 11C, 11M, 11Y, and 11K having the same structure, are overlapped so that part of the ink ejection nozzles 18 positioned on one of the recording head 17a to 17c face part of the ink ejection nozzles 18 positioned on another in the paper transport direction.

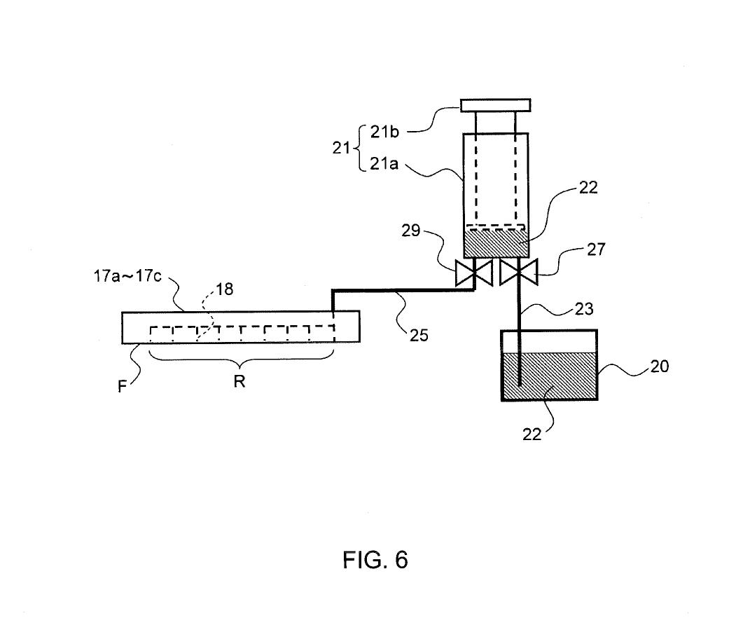

The recording heads 17a to 17c, constituting one of the line heads 11C, 11M, 11Y, and 11K, receive one of four inks (cyan, magenta, yellow, and black) stored in an ink tank 20 (see FIG. 6) corresponding to the color of the relevant line head 11C, 11M, 11Y, or 11K.

The recording heads 17a to 17c each eject ink from the ink ejection nozzles 18 toward the paper P, which is held by the transport surface of the first transport belt 8 by being adsorbed and is fed, according to image data received from, for example, an external computer. Thus, a color image formed by a combination of the four inks, cyan, magenta, yellow and black, is recorded on the paper P on the first transport belt 8.

When the print operation stops for a long period of time, the recording heads 17a to 17c may dry or may become clogged and thereby ink may not be sufficiently ejected. To suppress insufficient ink ejection when a print operation restarts after a long stoppage, a purge operation may be performed by which viscous intra-nozzle ink is purged from the ink ejection nozzles 18 of all recording heads 17a to 17c. When the amount of ink ejection in some of the recording heads 17a to 17c falls to or below a prescribed value, this purge operation may also be performed for the ink ejection nozzles 18 of the relevant recording heads during the period when printing is not performed. This makes the inkjet recording apparatus 100 ready for a next print operation.

As the method of ejecting ink from the recording heads 17a to 17c, a piezoelectric method, in which a piezoelectric element (not shown) is used to extrude ink, can be applied. Other various examples include a thermal inkjet method, in which bubbles are formed by a heat generating body to apply a pressure, with which ink is ejected.

A second transport unit 12 is positioned downstream (right side in FIG. 1) of the first transport unit 5 in the paper transport direction. The second transport unit 12 includes a second drive roller 13 positioned at the downstream end in the paper transport direction, a second driven roller 14 positioned at the upstream end, and a second transport belt 15 tensioned between the second drive roller 13 and the second driven roller 14. When the second drive roller 13 rotates clockwise, the paper P held by the second transport belt 15 is fed in the direction indicated by the arrow X.

When the paper P on which an image has been recorded by the recording unit 9 is sent to the second transport unit 12. The ink ejected onto the surface of the paper P is dried while the paper P is passing through the second transport unit 12. A maintenance unit 19 is placed below the second transport unit 12. When the purge operation described above is executed, the maintenance unit 19 is placed below the recording unit 9. The maintenance unit 19 is selectively located at a maintenance position close to the ink ejection surfaces (ink ejection surfaces F described later) of the plurality of recording heads 17a to 17c of the recording unit 9 and a standby position apart from the ink ejection surfaces F. The maintenance unit 19 wipes ink ejected from the ink ejection nozzles 18 of the recording heads 17 after the purge operation. The maintenance unit also collects the ink that it has wiped off. The structure of the maintenance unit 19 will be described later.

A discharge roller pair 16 is provided downstream of the second transport unit 12 in the paper transport direction. The discharge roller pair 16 discharges the paper P on which an image has been recorded to outside of the main body of the inkjet recording apparatus. A discharge tray (not shown) is located downstream of the discharge roller pair 16 in the paper transport direction. Paper sheets P discharged to the outside of the inkjet recording apparatus are stacked on the discharge tray.

Next, how ink is supplied from the ink tank 20 to the recording heads 17a to 17c during printing and how ink is ejected from the recording heads 17a to 17c during a purge will be described. FIG. 6 schematically illustrates an ink flow path in the inkjet recording apparatus 100 in an embodiment of the present disclosure. The ink flow path extends from the ink tank 20 to the recording heads 17a to 17c. Although the ink flow path illustrated in FIG. 6 is located between the ink tank 20 in each color and the recording heads 17a to 17c in that color, the ink flow path in one color will be described below.

As illustrated in FIG. 6, a syringe pump 21 is located between the ink tank 20 and the recording heads 17a to 17c. The ink tank 20 and the syringe pump 21 are mutually linked through a first supply path 23 defined by, for example, a tube member. The syringe pump 21 and the ink ejection nozzles 18 in the recording heads 17a to 17c are mutually linked through a second supply path 25 defined by, for example, a tube member.

An inlet valve 27 is attached to the first supply path 23. An outlet valve 29 is attached to the second supply path 25. When the inlet valve 27 is opened and closed, movement of the ink in the first supply path 23 is allowed and restricted. When the outlet valve 29 is opened and closed, movement of the ink in the second supply path 25 is allowed and restricted.

The syringe pump 21 has a cylinder 21a and a piston 21b. The cylinder 21a is connected to the first supply path 23 and second supply path 25. Ink 22 included in the ink tank 20 flows into the cylinder 21a through the first supply path 23. The ink is discharged from the cylinder 21a through the second supply path 25. The discharged ink is supplied to the recording heads 17a to 17c. The supplied ink is ejected from the ink ejection nozzles 18 toward the nozzle areas R on the ink ejection surface F.

The piston 21b can be moved vertically by a drive apparatus (not shown). A packing (not shown) such as an O-ring is attached around the outer circumference of the piston 21b. The packing can suppress ink from leaking from the cylinder 21a. The packing also enables the piston 21b to smoothly slide along the inner circumference of the cylinder 21a.

The inlet valve 27 and outlet valve 29 are both open in normal times (during printing) as illustrated in FIG. 6. When the piston 21b is stopped at a predetermined position, the cylinder 21a is filled with a substantially fixed amount of ink. The ink 22 is supplied from the cylinder 21a to the recording heads 17a to 17c by surface tension (meniscuses) between the cylinder 21a and the recording heads 17a to 17c.

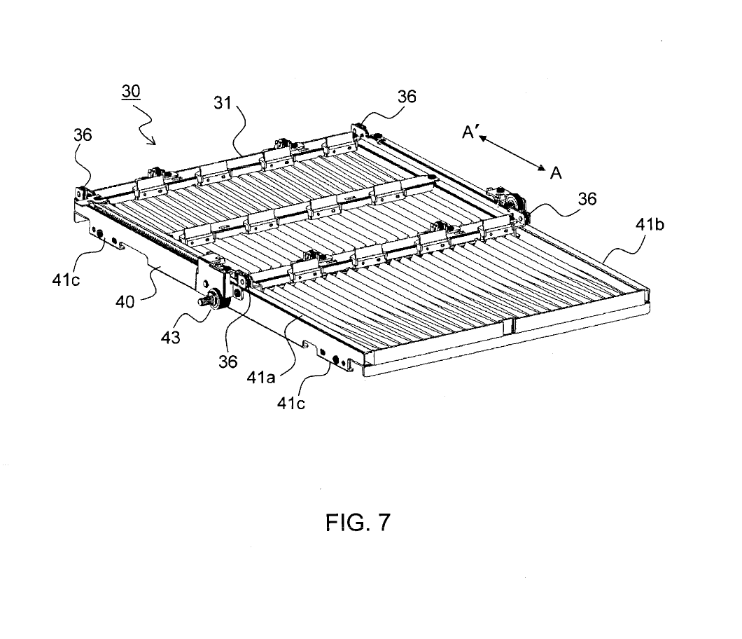

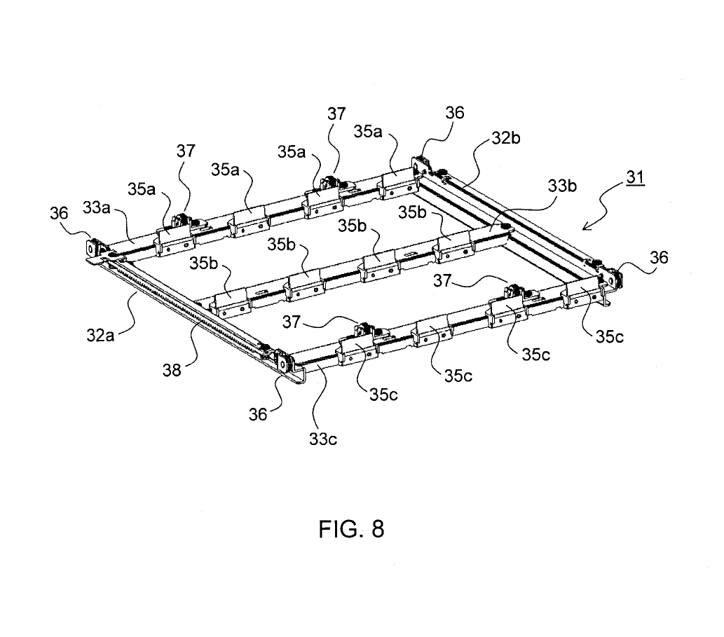

FIG. 7 is a perspective view of a wiping mechanism 30, in an embodiment of the present disclosure, which is mounted in the maintenance unit 19. The wiping mechanism 30 includes a substantially rectangular carriage 31 to which a plurality of wipers 35a to 35c (see FIG. 8) are secured and also has a support frame 40 that supports the carriage 31. Rails 41a and 41b are formed along opposing edges of the support frame 40. When sliding rollers 36 provided at the four corners of the carriage 31 abut the rails 41a and 41b, the carriage 31 is supported so as to be slidable on the support frame 40 in directions indicated by the arrow AA′.

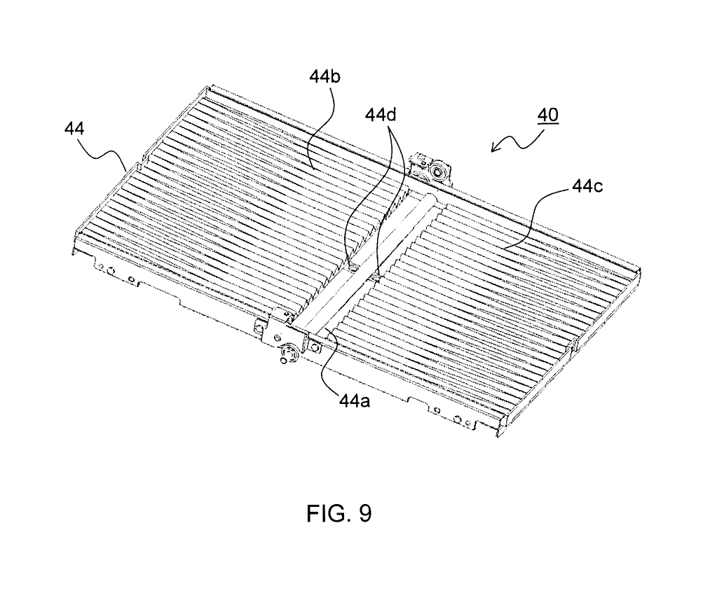

FIG. 8 is a perspective view of the carriage 31, which is part of the wiping mechanism 30. FIG. 9 is a perspective view of the support frame 40, which is part of the wiping mechanism 30. As illustrated in FIG. 8, the carriage 31 is formed in a frame shape by using first stays 32a and 32b that slidably engage the rails 41a and 41b of the support frame 40 through the sliding rollers 36 as well as second stays 33a, 33b, and 33c that are secured like bridges between the first stays 32a and 32b. As illustrated in FIGS. 7 and 9, the support frame 40 has a rectangular form with two sides extending parallel to the recording medium transport direction and two sides extending parallel to a direction orthogonal to the recording medium transport direction.

The first stay 32a has a rack tooth 38 that engages an input gear 43 (see FIG. 7) retained on the support frame 40. When the input gear 43 rotates in the normal and reverse directions, the carriage 31 bidirectionally moves in a horizontal direction (direction indicated by the arrow AA′ in FIG. 7) along the support frame 40.

The wipers 35a to 35c wipe off ink ejected from the ink ejection nozzles 18 of the recording heads 17a to 17c. During the wiping operation in this embodiment, the wipers 35a to 35c are each brought into pressure contact to a wiping start position from a substantially vertical direction. The wiping start position is located outside the nozzle areas R (see FIG. 5), where the nozzle surfaces of the ink ejection nozzles 18 are exposed. When the carriage 31 moves, the wipers 35a to 35c each wipe the ink ejection surface F including the nozzle areas R in the prescribed direction indicated by the arrow A in FIG. 7. In this embodiment, the plurality of wipers 35a to 35c are selectively located at a wiping position and a distant position apart from the ink ejection surface. At the wiping position, when the maintenance unit 19 is located at the maintenance position, the recording heads 17a to 17c come close to their relevant ink ejection surfaces F and perform wiping.

Four wipers 35a are secured to the second stay 33a at substantially equal intervals. Similarly, four wipers 35b are secured to the second stay 33b at substantially equal intervals, and four wipers 35c are secured to the second stay 33c at substantially equal intervals. The wipers 35a and 35c are located at positions corresponding to the recording heads 17a and 17c (see FIG. 3), on the right and left, included in the line heads 11C, 11M, 11Y, and 11K. The wipers 35b are located at positions corresponding to the central recording heads 17b (see FIG. 3) included in the line heads 11C, 11M, 11Y, and 11K. Each wiper 35b is displaced by a prescribed distance with respect to the relevant wipers 35a and 35c in a direction orthogonal to the direction (indicated by the arrow AA′ in FIG. 7) in which the carriage 31 moves.

Gap rollers 37, for example, may be positioned at the four corners of the upper surfaces of the second stays 33a and 33c. The gap rollers 37 allow the wipers 35a to 35c to wipe the ink ejection surfaces F of the recording heads 17a to 17c. When the wiping mechanism 30 is raised toward the recording unit 9 and the wipers 35a to 35c abut the head housing 10 of the recording unit 9, a state where the wipers 35a to 35c are brought into contact with corresponding ink ejection surfaces F can be fixed. That is, with the wipers 35a to 35c in contact with corresponding ink ejection surfaces F, fixed spacings are maintained between the wipers 35a to 35c and corresponding ink ejection surfaces F by the gap rollers 37. While, for example, the wiping operation is being performed, prescribed spacings are maintained between the wipers 35a to 35c and their corresponding ink ejection surfaces F.

Flexible members formed of an elastic material, for example, are used as the wipers 35a to 35c. Rubber blades or the like, for example, are used as the wipers 35a to 35c. The wipers 35a to 35c are designed so that when a wiping operation is being performed, they are warped with their tops in contact with their corresponding ink ejection surfaces F. For instance, a distance, measured before the wipers 35a to 35c are warped, from the places, on the carriage 31, at which the wipers 35a to 35c are located (that is, from upper surfaces of the second stays 33a to 33c, for example) to the tops of the wipers 35a to 35c may be denoted Lp (mm). The distance from the carriage 31 to the ink ejection surface F after the wipers 35a to 35c have been warped may be set so as to be, for example, Lp −1.0 (mm). In this case, the amount by which each of the wipers 35a to 35c protrudes from the ink ejection surface F (also referred to as an overlap amount by which the wiper enters the ink ejection surface) is set to about 1.0 mm. In the wiping operation, therefore, the wipers 35a to 35c are held so that the amount by which each of them is warped with respect to the ink ejection surface is retained to be fixed by the use of the gap rollers 37. With the wipers 35a to 35c in contact with their corresponding ink ejection surfaces F, they are held so that the distance between each of the wipers 35a to 35c and the ink ejection surface F is maintained at a fixed value in this way. That is, while the wiping operation is being performed, the wipers 35a to 35c are held so that the distance between each of them and the ink ejection surface F is maintained at a prescribed value. Thus, the state in which the wipers 35a to 35c are in contact with their corresponding ink ejection surfaces F is fixed during a wiping operation. The amount by which each of the wipers 35a to 35c is warped (that is, the amount by which each of the wipers 35a to 35c protrudes from the ink ejection surface F) may be set to a value other than 0.5 mm. For example, the amount of warp may be appropriately set in consideration of the degree of the flexibility of the wipers 35a to 35c, their wiping performance, and the like.

As illustrated in FIG. 9, an ink collecting tray 44 may be placed on the upper surface of the support frame 40. Waste ink wiped off from the ink ejection surfaces F by the wipers 35a to 35c is collected in the ink collecting tray 44. A groove 44a is formed substantially at the center of the ink collecting tray 44 along the direction in which the second stays 33a to 33c extend. Tray surfaces 44b and 44c on both sides of the groove 44a each have a downward slope toward the groove 44a. That is, the tray surfaces 44b and 44c on both sides of the groove 44a are formed so as to be downwardly inclined toward the groove 44a Ink discharge holes 44d are formed in the groove 44a. The bottom surfaces of the groove 44a are formed so as to be downwardly inclined toward the ink discharge holes 44d.

The waste ink wiped off from the ink ejection surfaces F by the wipers 35a to 35c drops on the tray surfaces 44b and 44c and is collected into the groove 44a. The waste ink then flows in the groove 44a toward the ink discharge holes 44d. The waste ink passes through ink collection path (not shown) linked to the ink discharge holes 44d and is collected in an ink collection tank (not shown).

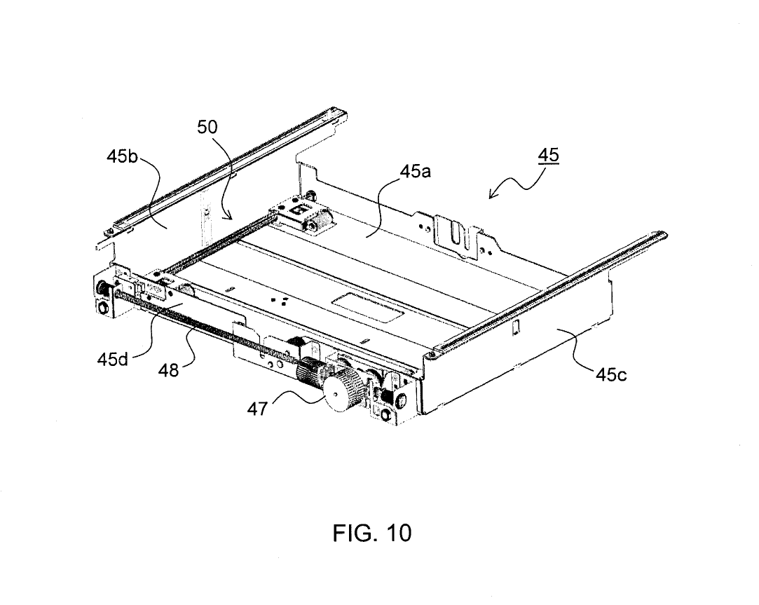

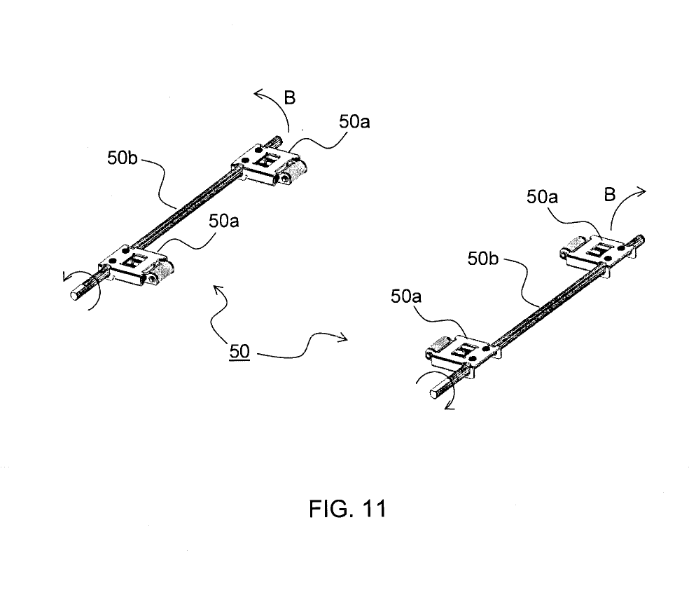

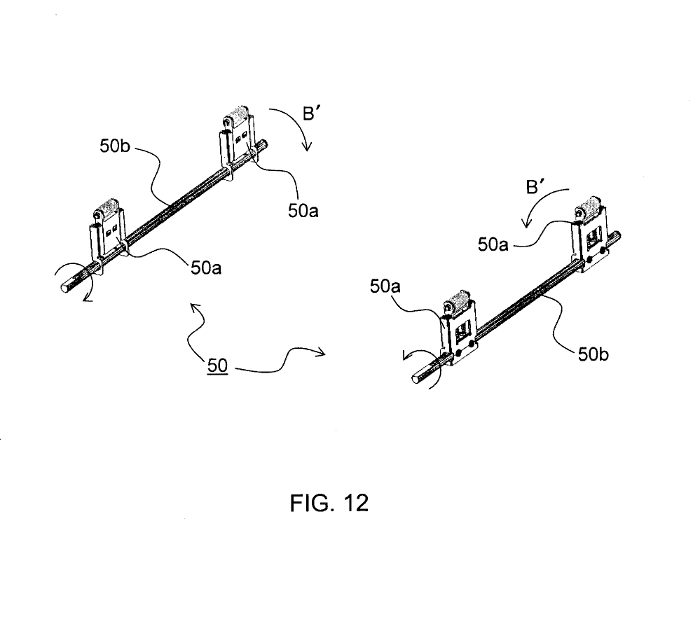

Next, a raising-and-lowering mechanism 50 included in the wiping mechanism 30 will be described. FIG. 10 is an external perspective view of a unit case 45 of the maintenance unit 19 with the wiping mechanism 30 removed. FIGS. 11 and 12 are each a perspective view of the raising-and-lowering mechanism 50 located in the unit case 45. The raising-and-lowering mechanism 50 includes a plurality of lift members 50a and a plurality of shafts 50b. Two raising-and-lowering mechanisms 50 are located on the bottom surface 45a of the unit case 45 along side surfaces 45b and 45c facing each other in a direction in which the carriage 31 moves (direction indicated by the arrow AA′ in FIG. 7). That is, the raising-and-lowering mechanisms 50 are placed at mutually opposing positions at both ends of the head housing 10 of the recording unit 9 in its width direction (that is, vertical ends in FIG. 2). The plurality of shafts 50b are located in correspondence to two edges, of the rectangular support frame 40, that extend in parallel in a direction orthogonal to the recording medium transport direction. The plurality of shafts 50b may be located in correspondence to two edges that extend in parallel in the recording medium transport direction. In FIG. 10, the raising-and-lowering mechanism 50 on the same side as the side surface 45c of the unit case 45 is not drawn. A motor 47 and a driving transmission axis 48, which transmits the rotational driving force of the motor 47 to the raising-and-lowering mechanism 50, are added to a side surface 45d of the unit case 45, the side surface 45d being adjacent to the side surfaces 45b and 45c of the unit case 45.

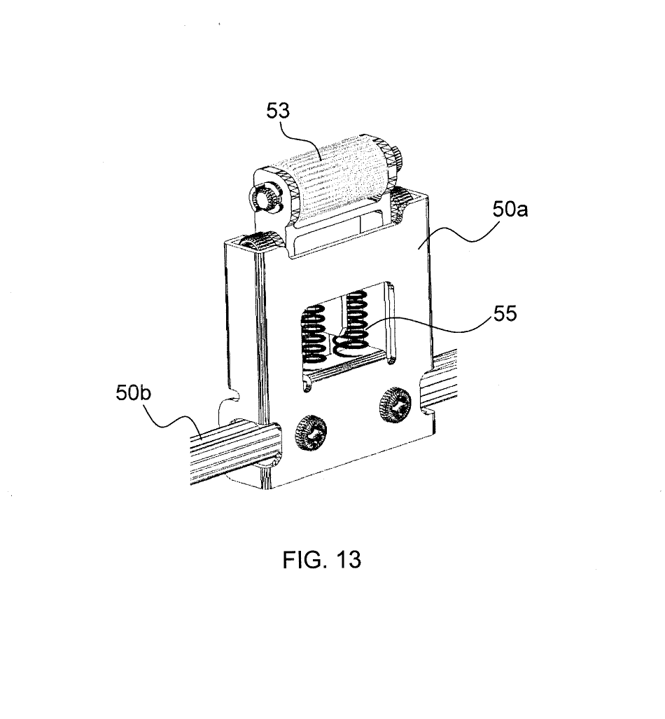

FIG. 13 is a perspective view of the lift member 50a, which is part of the raising-and-lowering mechanism 50. The lower part of the lift member 50a is secured to the shaft 50b. A lifting roller 53 is rotatably placed on the upper part of the lift member 50a. The lifting roller 53 engages an engaging part 41c (see FIG. 7) formed on the lower part of the support frame 40. The lifting roller 53 can be rotatably moved along the engaging part 41c. Accordingly, when the raising-and-lowering mechanism 50 is operated, friction between the support frame 40 and the lift member 50a is reduced by rotation of the lifting roller 53, enabling the wiping mechanism 30 to be smoothly raised and lowered. The lifting roller 53 is urged by a coil spring 55 away from the shaft 50b (in FIG. 13, the upward direction).

When the shaft 50b of the raising-and-lowering mechanism 50 on the right side is rotated clockwise from the state illustrated in FIG. 11, that is, the lift members 50a of the raising-and-lowering mechanism 50 are placed horizontally and the shaft 50b of the raising-and-lowering mechanism 50 on the left side is rotated counterclockwise from the same state, each lift member 50a falling down toward the interior of the unit case 45 extends outwardly (in the direction indicated by the arrow B). At this time, the lifting roller 53 is moved to the outer end of the engaging part 41c. The lift member 50a is therefore switched from the horizontal state to an extended state (the state illustrated in FIG. 12, that is, a state in which the lift members 50a of the raising-and-lowering mechanism 50 are extended). Thus, the lift members 50a raise the carriage 31 together with the support frame 40.

When the shaft 50b of the raising-and-lowering mechanism 50 on the right side is rotated counterclockwise from the state illustrated in FIG. 12 and the shaft 50b of the raising-and-lowering mechanism 50 on the left side is rotated clockwise from the same state, each lift member 50a falls down toward the interior of the unit case 45 (in the direction indicated in the arrow B′). At this time, the lifting roller 53 is moved to the inner end of the engaging part 41c. The lift member 50a is therefore switched from the extended state to the horizontal state (the state illustrated in FIG. 11). Thus, the lift members 50a lower the carriage 31 together with the support frame 40.

In the structure described above, the lift member 50a raises and lowers the plurality of wipers 35a to 35c by raising-and-lowering the support frame 40. When the lift members 50a are switched from the horizontal state to the extended state, the plurality of wipers 35a to 35c are raised and are located at their corresponding wiping positions. When the lift members 50a are switched from the extended state to the horizontal state, the plurality of wipers 35a to 35c are lowered and are located at their corresponding standby positions. The angles of inclination of the lift members 50a may be the same while they are being switched between the extended state and the horizontal state. While the lift member 50a is being switched, its angle of inclination may be, for example, an angle relative to the bottom surface 45a of the unit case 45.

For example, during a switchover from the horizontal state illustrated in FIG. 11 to the extended state illustrated in FIG. 12, the counterclockwise inclination angle of the raising-and-lowering mechanism 50 on the left side, in FIG. 12, relative to the bottom surface 45a of the unit case 45 and the clockwise inclination angle of the raising-and-lowering mechanism 50 on the right side, in FIG. 12, relative to the bottom surface 45a of the unit case 45 may be the same. During a switchover from the extended state illustrated in FIG. 12 to the horizontal state illustrated in FIG. 11, the counterclockwise inclination angle of the raising-and-lowering mechanism 50 on the left side, in FIG. 12, relative to the bottom surface 45a of the unit case 45 and the clockwise inclination angle of the raising-and-lowering mechanism 50 on the right side, in FIG. 12, relative to the bottom surface 45a of the unit case 45 may be the same.

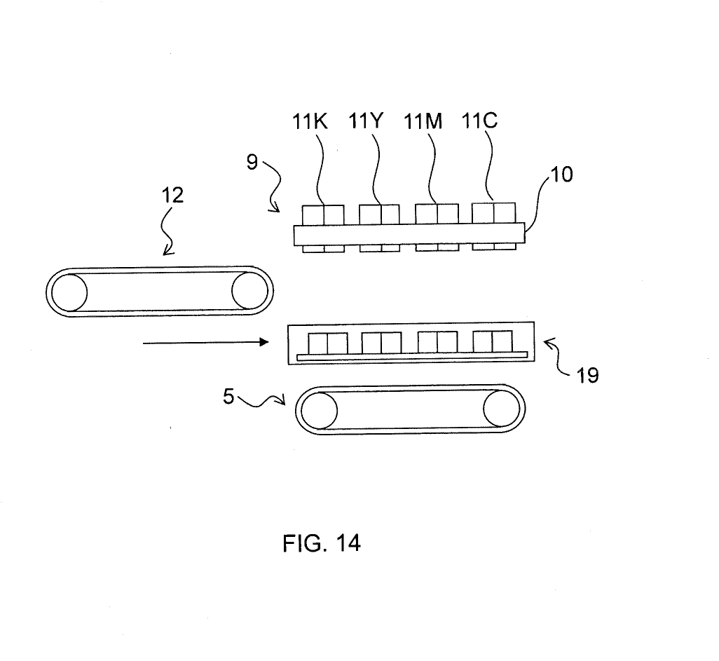

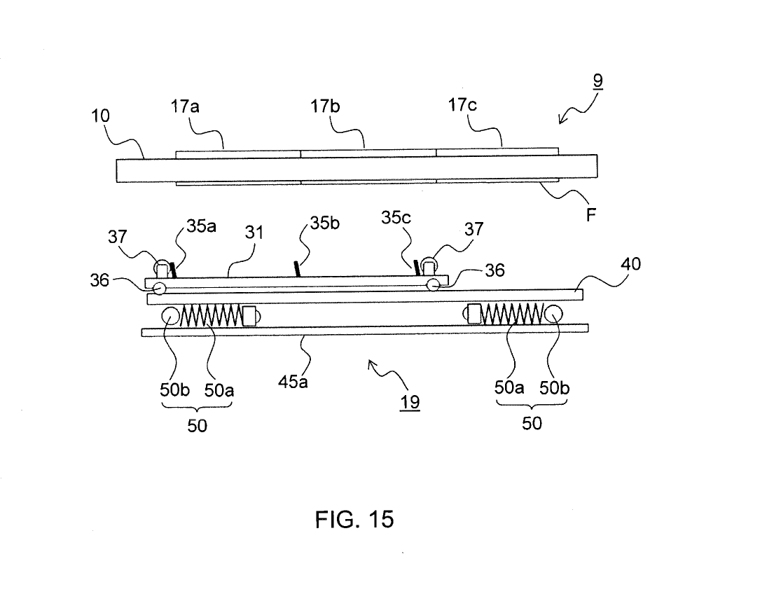

The rotational operation of the recording heads 17a to 17c that use the wiping mechanism 30 of the inkjet recording apparatus 100 in an embodiment of the present disclosure will be described. FIG. 14 is a side view illustrating when the maintenance unit 19 is placed below the recording unit 9. FIGS. 15 to 19 are each a side view of the maintenance unit 19, illustrating its operation during the wiping of the recording heads 17a to 17c. In FIGS. 15 to 19, the support frame 40 is simply illustrated in a plate shape. In FIGS. 15 to 19, only the bottom surface 45a is illustrated to represent the unit case 45. In FIGS. 15 to 19, the recording unit 9 and maintenance unit 19 are viewed from the downstream side of the paper transport direction (from the left side in FIG. 14).

When the recording heads 17a to 17c are rotated, the first transport unit 5 located below the recording unit 9 as illustrated in FIG. 14 is lowered first. The maintenance unit 19 located below the second transport unit 12 is then horizontally moved to a position between the recording unit 9 and the first transport unit 5. At this time, the lift member 50a of the raising-and-lowering mechanism 50 is horizontally placed as illustrated in FIG. 15. Therefore, the wipers 35a to 35c secured to the carriage 31 are apart from the ink ejection surfaces F of the recording heads 17a to 17c.

Before the wiping operation is started, when the inlet valve 27 (see FIG. 6) is closed in a state when printing by the recording heads 17a to 17c is not performed to pressurize the syringe pump 21 (see FIG. 6), the ink 22 in the cylinder 21a is supplied to the recording heads 17a to 17c through the second supply path 25. The supplied ink 22 is forcibly ejected (purged) from the ink ejection nozzles 18. Due to this purge operation, viscosity ink, foreign matter, and bubbles in the ink ejection nozzles 18 can be discharged and the recording heads 17a to 17c can be restored.

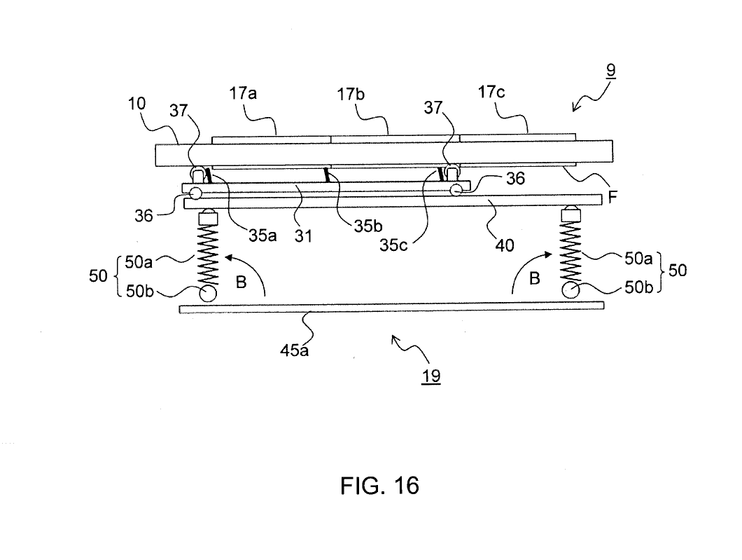

A wiping operation, by which the ink 22 ejected to the ink ejection surface F is wiped off, is then performed. Specifically, as illustrated in FIG. 16, the shaft 50b of the raising-and-lowering mechanism 50 is rotated to extend the lift member 50a in the direction indicated by the arrow B and thereby to raise the support frame 40 and carriage 31. Thus, as illustrated in FIG. 16, the wipers 35a to 35c are located at the wiping start positions (near the upstream ends on the ink ejection surfaces F) of the ink ejection surfaces F of the recording heads 17a to 17c. At this time, the gap rollers 37 attached to the carriage 31 are pressed against the lower surface of the head housing 10 by the coil springs 55 (see FIG. 13) of the lift members 50a. This enables the wipers 35a to 35c to be constantly brought into pressure contact with their corresponding ink ejection surfaces F with a fixed pressure.

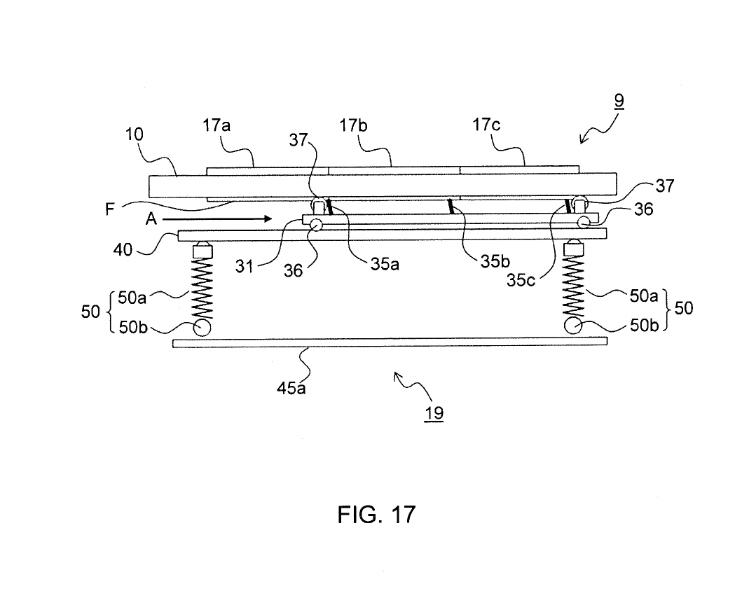

When the input gear 43 (see FIG. 7) is rotated in the normal direction to move the carriage 31 in the direction indicated by the arrow A as illustrated in FIG. 17, the wipers 35a to 35c wipe off ink ejected to the ink ejection surfaces F of the recording heads 17a to 17c. At this time, an upward force is exerted on the support frame 40 by the raising-and-lowering mechanisms 50. Accordingly, the carriage 31 moves in the direction indicated by the arrow A while the gap rollers 37 are kept pressed against the head housing 10. The waste ink wiped off by the wipers 35a to 35c is collected in the ink collecting tray 44 (see FIG. 9).

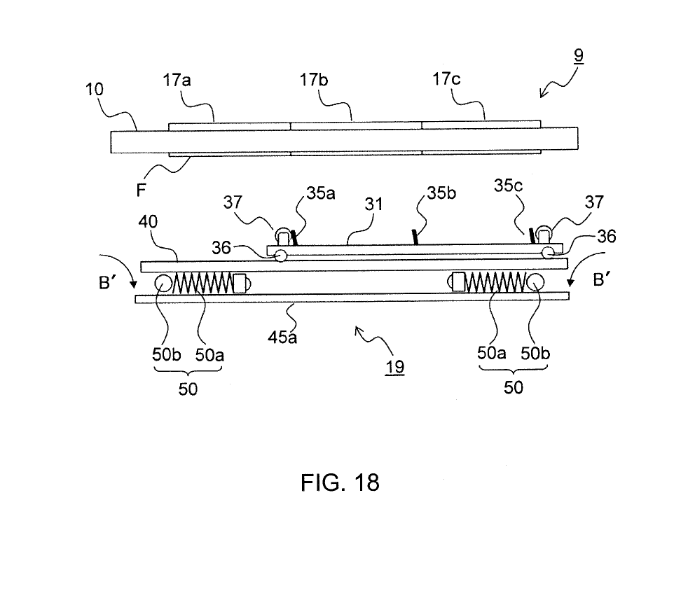

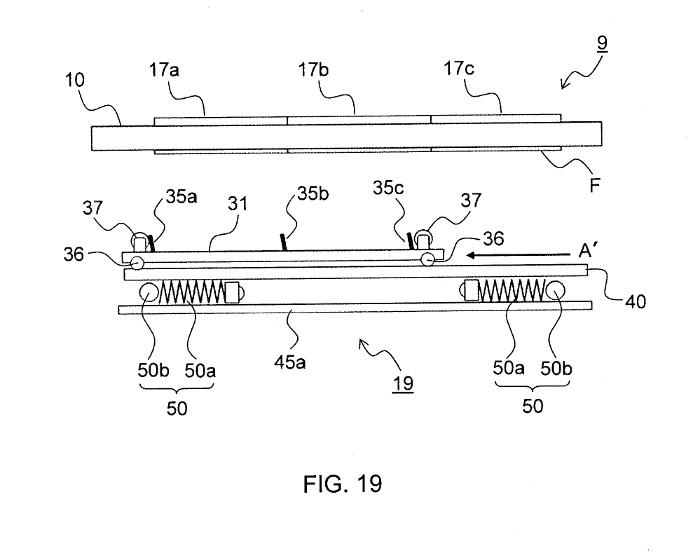

After the wipers 35a to 35c have moved to the downstream ends (right end in FIG. 17) of the ink ejection surfaces F of the recording heads 17a to 17c, the shaft 50b of the raising-and-lowering mechanism 50 is rotated to cause the lift member 50a to fall down in the direction indicated by the arrow B′ as illustrated in FIG. 18. The support frame 40 and carriage 31 are then lowered. Thus, the wipers 35a to 35c are separated downwardly from the ink ejection surfaces F of the recording heads 17a to 17c. The carriage 31 is then moved in the direction indicated by the arrow A′ as illustrated in FIG. 19 by, for example, rotating the input gear 43 in the reverse direction to return the maintenance unit 19 to the state illustrated in FIG. 15. The maintenance unit 19 placed between the recording unit 9 and the first transport unit 5 is horizontally moved so as to be placed below the second transport unit 12. The first transport unit 5 is raised to a prescribed position in this way, completing the operation to restore the recording heads 17a to 17c.

In an embodiment, as described above, the three wipers 35a to 35c are secured in a direction in which the carriage 31 moves (the direction indicated by the arrow AA′). When the carriage 31 is bidirectionally moved and raised and lowered by the raising-and-lowering mechanisms 50, these wipers 35a to 35c can wipe the ink ejection surfaces F of the three recording heads 17a to 17c, which are part of each of the line heads 11C, 11M, 11Y, and 11K, in a single operation.

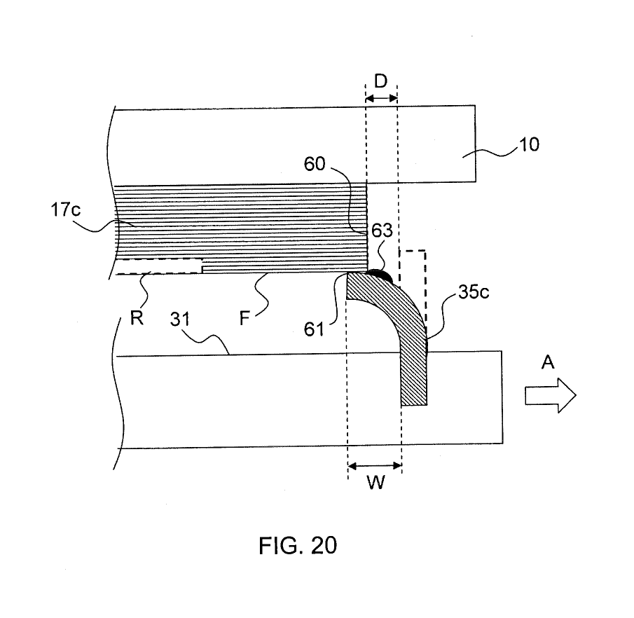

FIG. 20 is an enlarged view illustrating a position at which the wiper 35c, which is part of the wiping mechanism 30 in the first embodiment, stops after the ink ejection surface F has been wiped. The operation of the wiper 35c to wipe the ink ejection surface F of the recording head 17c will be described. The operations of the wipers 35a and 35b to wipe the ink ejection surfaces F of their corresponding recording heads 17a and 17b are completely the same as the operation of the wiper 35c. Therefore, their descriptions will be omitted.

In this embodiment, the wiper 35c stops at a position where distance D from an edge 60 at the downstream end of the recording head 17c in the wiping direction indicated by the arrow A to the upstream edge of the wiper 35c when the wiper 35c is not warped (the state is indicated by the dashed lines in FIG. 20) does not exceed an amount W of warp (a first amount of warp) in the direction in which the wiper 35c moves during an operation to wipe the ink ejection surface F. At this time, the top 61 of the wiper 35c abuts a portion inside (leftward in FIG. 20) the edge 60 at the downstream end of the recording head 17c. An ink droplet 63, which has been wiped off from the ink ejection surface F, is adhering to the top 61 of the wiper 35c.

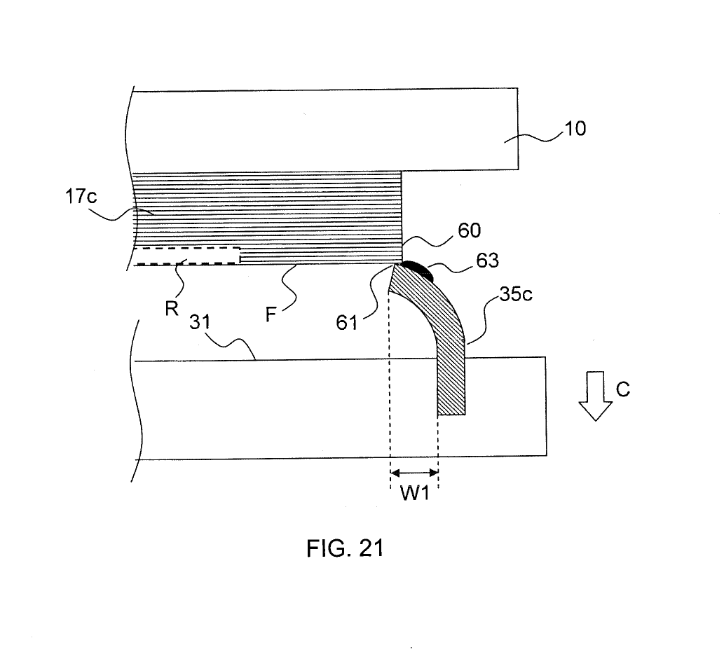

The support frame 40 and carriage 31 (see FIG. 18) are then moved downwardly (in the direction indicated by the arrow C). Thus, the wiper 35c is gradually moved away from the ink ejection surface F as illustrated in FIG. 21. The wiper 35c is deformed due to its restoration force from a state in which the wiper 35c is largely warped by the amount W of warp as illustrated in FIG. 20 to a state in which the wiper 35c is less warped. As the wiper 35c is deformed, the top 61 of the wiper 35c moves to the vicinity of the edge 60 at the downstream end of the recording head 17c.

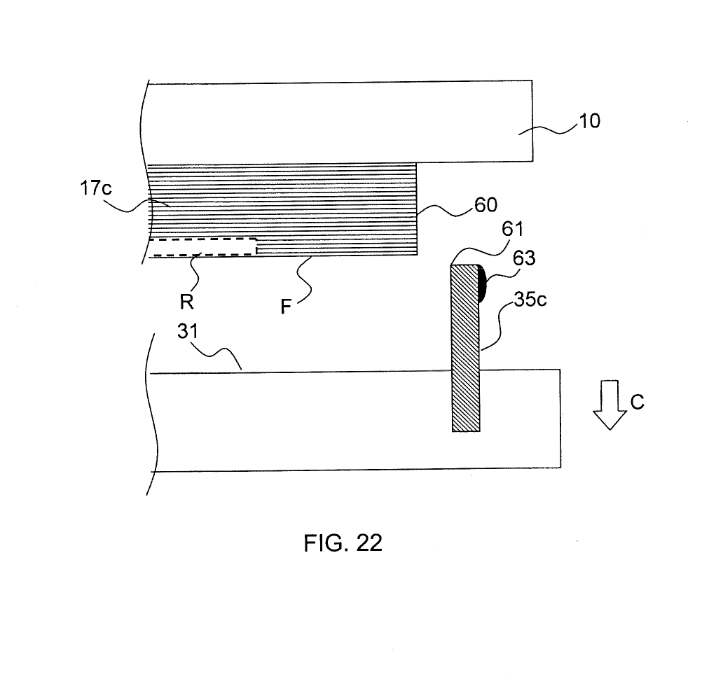

The support frame 40 and carriage 31 are further moved downwardly (in the direction indicated by the arrow C). Thus, as illustrated in FIG. 22, the top 61 of the wiper 35c passes through the edge 60 at the downstream end of the recording head 17c. Therefore, the wiper 35c is completely separated from the ink ejection surface F, restoring the wiper 35c to its original shape (flat plate shape). Since the warp of the wiper 35c is released at one time, the wiper 35c undergoes stress and thereby vibrates. However, the amount W1 of warp (second amount of warp) caused when the top 61 of the wiper 35c passes through the edge 60 is smaller than the amount W of warp (first amount of warp) caused while the ink ejection surface F is being wiped.

Accordingly, the wiper 35c vibrates less when compared with a structure in which after the top 61 of the wiper 35c has passed through the edge of the ink ejection surface F, the wiper 35c is stopped. This can suppress the ink droplet 63 adhering to the wiper 35c from scattering. When moving away from the ink ejection surface F, the wiper 35c generates a restoration force. Due to the restoration force, the top 61 of the wiper 35c passes through the edge 60. Accordingly, the wiper 35c can reliably wipe the ink ejection surface F to its edge 60. It is also possible to reduce the possibility that ink remaining on the ink ejection surface F drops to paper passing below the ink ejection surface F or comes into contact to the paper, which would otherwise contaminate the printing surface.

It is preferable to set the stop position of the wiper 35c so that the amount W1 of warp (second amount of warp) caused when the top 61 of the wiper 35c passes through the edge 60 does not exceed the maximum amount of warp up to which even if the wiper 35c vibrates, the ink droplet 63 adhering to the wiper 35c does not scatter. Then, it is possible to more reliably suppress the ink droplet 63 adhering to the wiper 35c from scattering when the top 61 of the wiper 35c passes through the edge 60. The maximum amount of warp up to which the ink droplet 63 adhering to the wiper 35c does not scatter varies depending on the material and thickness of the wiper 35c, the wettability of the surface of the wiper 35c, the viscosity of the ink droplet 63, and other factors. Accordingly, the amount W1 of warp may be adjusted by changing the stop position of the wiper 35c according to, for example, the specifications of the wiper 35c and the composition of the ink droplet 63.

When the stop positions of the wipers 35a and 35b, which wipe the ink ejection surfaces F of the recording heads 17a and 17b, are controlled in the same way, it is possible to completely wipe off ink to the edges 60 of the recording heads 17a to 17c and to efficiently reduce the ink droplet 63 from scattering due to the vibration of the wipers 35a to 35c, which is caused when they are moved away from their corresponding ink ejection surfaces F.

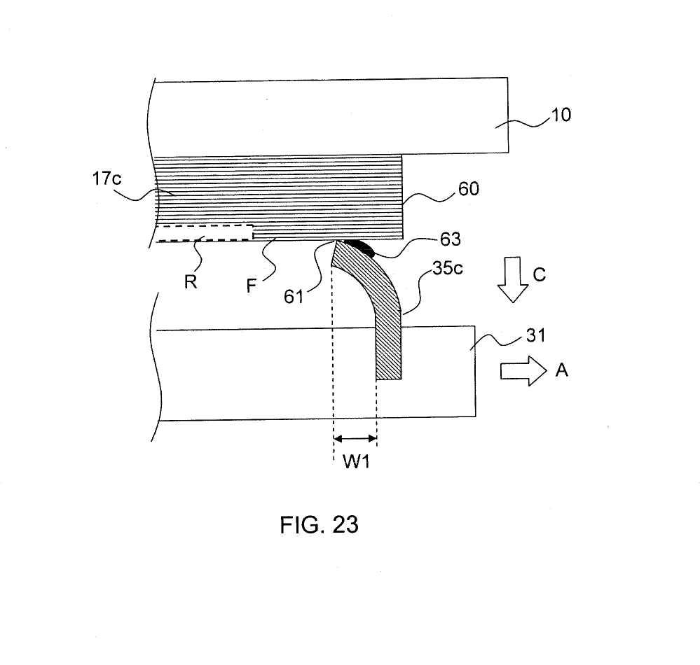

FIG. 23 is an enlarged view illustrating when the wiper 35c, which is part of the wiping mechanism 30 in another embodiment of the present disclosure, is moving in the wiping direction indicated by the arrow A. The structure of the wiping mechanism 30 is the same as in the previous embodiment illustrated in FIGS. 7 to 12. The operation of the wiper 35c to wipe the ink ejection surface F of the recording head 17c will be described below. The operations of the wipers 35a and 35b to wipe the ink ejection surfaces F of their corresponding recording heads 17a and 17b are completely the same as the operation of the wiper 35c. Therefore, their descriptions will be omitted.

In this embodiment, after the wiper 35c has passed through the nozzle areas R, where the nozzle surfaces of the ink ejection nozzles 18 are exposed, the support frame 40 and carriage 31 are moved downwardly (in the direction indicated by the arrow C) by a prescribed distance while the wiper 35c is being moved in the wiping direction indicated by the arrow A. Thus, the amount W1 of warp in the movement direction of the wiper 35c can be made less than the amount W of warp (see FIG. 20) caused while the wiper 35c is passing through the nozzle areas R (ink is being wiped off).

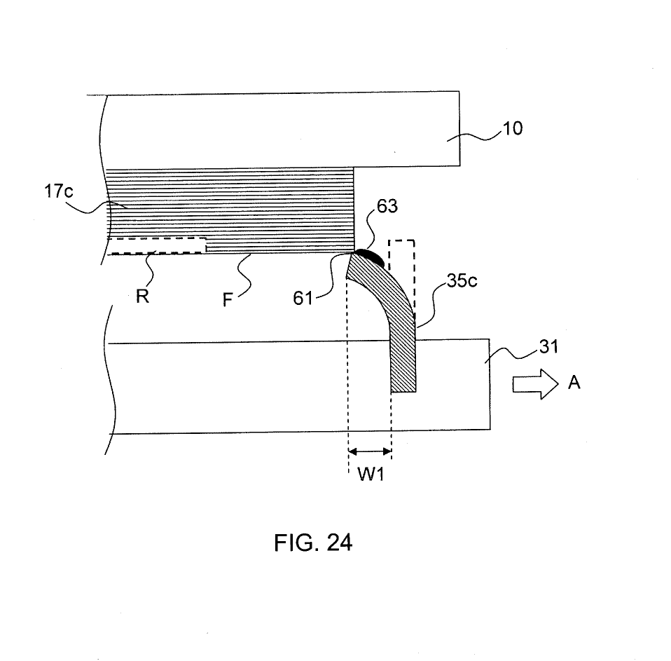

The wiper 35c passes through the edge 60 of the recording heads 17c while the amount W1 of warp is maintained, as illustrated in FIG. 24. The wipers 35a and 35b that wipe the ink ejection surfaces F of their corresponding recording heads 17a and 17b are controlled in the same way.

When the wipers 35a to 35c pass through the edges 60 of the recording heads 17a to 17c, their warp is released. Therefore, the wipers 35a to 35c undergo stress and thereby vibrate. However, the amount W1 of warp (second amount of warp) caused when the top 61 of each of the wipers 35a to 35c passes through the edge 60 is less than the amount W of warp (first amount of warp) during ink wiping. Therefore, as in the previous embodiment, it is possible to completely wipe off ink adhering to the edges 60 of the recording heads 17a to 17c and to efficiently suppress the ink droplet 63 from scattering due to the vibration of the wipers 35a to 35c. When ink is wiped off (for example, when the nozzle areas R are wiped by the wipers 35a to 35c), the amount W of warp of each of the wipers 35a to 35c is maintained. Therefore, ink can be more reliably wiped off by bringing the wipers 35a to 35c into tight contact with the nozzle areas R.

In this embodiment as well, it is preferable to reduce the amount W1 of warp caused when the tops 61 of the wipers 35a to 35c pass through the relevant edges 60 to or below the maximum amount of warp up to which even if the wipers 35a to 35c vibrate, the ink droplet 63 adhering to the wiper 35c does not scatter. Then, it is possible to more reliably reduce the ink droplet 63 adhering from scattering.

As described above, various methods of suppressing ink from scatting have been proposed.

For example, as described above, an inkjet apparatus has been proposed in which a wiping support member made of a flexible material is used so that the wiping support member is twisted when a wiping member slides on a nozzle surface. This may cause deformation of the wiping member to be gradually eliminated to restore the wiping member to its original state. In this method, however, when the wiping support member is twisted, the amount of warp of the wiping member itself is reduced. Therefore, the force with which the wiping member is pressed against the ink ejection surface is lowered. Accordingly, it is believed that the tightness of contact between the wiping member and the ink ejection surface may be lowered.

For example, as described above, a recording apparatus has been proposed where a slope member is provided along which a wiper blade is guided so as to move away from a string of nozzles so that the warp of the wiper blade is gradually eliminated. In this method, however, a member that guides the wiper needs to be separately provided. Therefore, the number of members and the cost may increase.

For example, as described above, inkjet recording apparatus has been proposed where a wiper is moved in the wiping direction, from one end of the ink ejection surface toward another end, and the wiper is moved away from the ink ejection surface at a change position where the ability to have ink adhere to the wiper is changed so as to be increased between the other end and the opening of a nozzle closest to the other end. In this method, however, since the wiper is moved away from the ink ejection surface short of its end, ink adhering to the wiper may remain on the ink ejection surface. The remaining ink may drop to the recording medium that passes below the ink ejection surface or may come into contact with the recording medium. This can contaminate the printing surface.

With this inkjet recording apparatus, after the wiper has been moved tentatively away from the ink ejection surface, ink adhering to the wiper may be absorbed by an ink absorbent. Then, the wiper may be brought again into contact with the ink ejection surface at a position slightly upstream of the position at which the wiper has been moved away and may wipe off the ink. The amount of warp after the wiper has been brought again into contact with the ink ejection surface may be smaller than the amount of warp before the wiper had been moved away. In this method, however, the movement of the wiper may not be easily controlled and the time taken to wipe may be thereby prolonged.

The embodiments of this disclosure provide a wiping mechanism that can reliably and quickly wipe the ink ejection surface with a simple structure and efficiently reduce ink from scattering due to the restoration force of the wiper, as described above, and also provide inkjet recording apparatus having the wiping mechanism.

In the embodiments of this disclosure, described above, the second amount of warp caused when the top of the wiper passes through the edge of the ink ejection surface is less than the first amount of warp caused while the nozzle area is being wiped. Accordingly, after the wiper passes through the downstream edge of the ink ejection surface, vibration caused by the restoration force of the wiper is reduced. This can suppress an ink droplet adhering to the wiper from scattering. Since the top of the wiper is reliably brought into contact with the ink ejection surface, it is also possible to suppress an ink droplet from remaining on the ink ejection surface. In addition, the scattering of the ink droplet can be reduced with the wiper being kept in contact with the ink ejection surface, without having to remove the wiper away from the ink ejection surface during wiping or to wipe off the ink adhering to the wiper. This may reduce the time taken for wiping.

In the embodiments of this disclosure, after the driving mechanism has stopped the wiper at a position where the distance from the edge of the ink ejection surface on the downstream side in the wiping direction to the upstream edge of the wiper in a state in which the wiper is not warped does not exceed the first amount of warp, the driving mechanism may move the wiper away from the ink ejection surface.

In this structure, after the wiper has stopped, the wiper passes through the edge of the ink ejection surface due to its restoration force generated when the wiper moves away from the ink ejection surface, with the second amount of warp, which is less than the first amount of warp. Thus, it is possible to suppress an ink droplet adhering to the wiper from scattering only by causing the wiper to stop and move away from the ink ejection surface, enabling the driving of the wiper to be simply controlled.

In the embodiments of this disclosure, as described above, the driving mechanism may stop the wiper at a position at which the second amount of warp does not exceed the maximum amount of warp up to which the ink droplet adhering to the wiper does not scatter when the warped wiper is restored to its original shape.

In this structure, the wiper is stopped at a position at which the second amount of warp does not exceed the maximum amount of warp up to which the ink droplet adhering to the wiper does not scatter when the warped wiper is restored to its original shape. Accordingly, it is possible to more reliably suppress an ink droplet adhering to the wiper from scattering.

In the embodiments of this disclosure, as described above, the driving mechanism may move the wiper away from the ink ejection surface while continuing to move the wiper in the wiping direction.

In this structure, when the wiper is moved away from the ink ejection surface while the wiper continues to be moved in the wiping direction, it becomes possible to suppress an ink droplet adhering to the wiper from scattering only by causing the wiper to perform wiping and move away from the ink ejection surface. This may enable the driving of the wiper to be simply controlled.

In the embodiments of this disclosure, as described above, a plurality of recording heads may be provided in the recording medium transport direction or a direction orthogonal to the recording medium transport direction, and a carriage is provided on which a plurality of wipers are secured corresponding to the recording heads; the driving mechanism may bidirectionally move the carriage and may raise and lower it to have the wipers concurrently wipe the ink ejection surfaces of the plurality of recording heads.

In this structure, since a plurality of wipers corresponding to the recording heads are secured to a carriage and the carriage is bidirectionally moved and raised and lowered to causes the plurality of wipers to concurrently wipe the ink ejection surfaces of the plurality of recording heads, the maintenance time taken for each recording heads can be shortened. Driving during maintenance can also be simplified.

The structure, described above, of the wiping mechanism in the embodiments of the present disclosure may be applied to an inkjet recording apparatus. An inkjet recording apparatus having the structure, described above, of the wiping mechanism in the embodiments of the present disclosure can efficiently prevent the interior of the apparatus from being contaminated by ink scattered when the wiper moves away from the ink ejection surface. The inkjet recording apparatus can also efficiently prevent a recoding medium from being contaminated by ink droplet remaining in the vicinity of the edge of the ink ejection surface on the downstream side.

The embodiments of the present disclosure described above are not a limitation; many variations are possible without departing from the intended scope of the present disclosure. For example, the driving mechanism of the carriage 31 including the rack tooth 38, input gear 43, and raising-and-lowering mechanism 50 is not limited to the driving mechanism described above; another driving mechanism may be used.

The number of ink ejection nozzles 18 of the recording heads 17a to 17c, the inter-nozzle spacing, and the like can be appropriately set according to the specifications of the inkjet recording apparatus 100. There is no particular limitation on the number of recording heads; for example, one, two, or four or more recording heads 17 may be positioned for each of the line heads 11C, 11M, 11Y, and 11K. When one, two, or four or more recording heads 17 are positioned for each line head, the number of wipers and their placement may also be changed according to the number of recording heads and their placement. When two or four or more recording heads 17 are positioned for each of the line heads 11C, 11M, 11Y, and 11K, two or four or more wipers may be positioned accordingly.

Although, in the above embodiments, an example has been described in which 12 wipers are positioned corresponding to the 12 recording heads, one wiper may be positioned for each color, for example. Alternatively, two wipers may be positioned for each color. For example, one wiper may be used for two recording heads 17a and 17c, illustrated in FIG. 2 and one wiper may be used for the recording head 17b.

Although, in the above embodiments, an example has been described in which the wipers 35a to 35c have moved orthogonal to the recording medium transport direction, the wipers may move, for example, parallel to the recording medium transport direction. When the wipers move parallel to the recording medium transport direction, the width of the wiper orthogonal to the recording medium transport direction may be equal to or greater than the width of the ink ejection surface of the recording head orthogonal to the recording medium transport direction.

The embodiments of the present disclosure can also be applied to a monochrome inkjet recording apparatus that includes only one of the line heads 11C, 11M, 11Y, and 11K. When an embodiment of the present disclosure is applied to a monochrome inkjet recording apparatus, only one set of recording heads 17a to 17c is placed. Accordingly, it suffices to secure only one set of the wipers 35a to 35c corresponding to the recording heads 17a to 17c to the carriage 31.

As for the timing of the wiping by the wiper, the wipers 35a to 35c of the line heads 11C, 11M, 11Y, and 11K (all colors) may concurrently perform wiping. Alternatively, the timings at which to start and terminate wiping and the timing at which to lower the wiper short of the edge of the ink ejection surface on the downstream side may be changed for each wiper.

Although, in the above embodiments, an example has been described where the wipers 35a to 35c wipe the ink ejection surfaces in one direction (for example, in FIGS. 15 to 19, from left to right), the structures in embodiments in the present disclosure may also be applied to a case where the wipers 35a to 35c wipe the ink ejection surfaces in a direction opposite to the direction in the example. The structures in the embodiments in the present disclosure may also be applied to an ink jet recording apparatus structured so that the ink ejection surface is wiped in two directions (for example, in FIGS. 15 to 19, a direction from left to right and a direction from right to left). When the ink ejection surface is wiped in two directions, the wiper may perform wiping by being stopped and moved away from the ink ejection surface at the end of the ink ejection surface in either direction, as described in the embodiments of the present disclosure.

Although, in the above embodiments, an example of inkjet recording heads of line head type has been described, the structures in the embodiments of the present disclosure can also be applied to another method. For example, the structures in the embodiments of the present disclosure can also be applied to wiping for inkjet recording heads of the serial type. Furthermore, the structures in the embodiments of the present disclosure can also be applied to an inkjet recording apparatus having recording heads of the serial type.

The effects provided by the embodiments of the present disclosure will be described below in more detail by using examples.

### EXAMPLES

The effect of suppressing ink from scattering by using the wiping mechanism 30 in an embodiment was investigated. First, a test machine was manufactured on which a rubber blade made of ethylene propylene diene monomer (EPDM) rubber (with an ASKER hardness of 60 and a rebound resilience of about 60%) with a width of 30 mm, a height of 7 mm high, and a thickness of 1.5 mm was attached to a carriage as a wiper, the carriage bidirectionally moving along the ink ejection surface of the recording head and also moving in a direction toward the ink ejection surface and in a direction away from the ink ejection surface.

The distance between the carriage and the ink ejection surface was set so that the amount by which the wiper entered the ink ejection surface (overlapped the ink ejection surface) became 1±0.3 mm, and the wiper was brought into pressure contact at a start position from which to start to wipe the ink ejection surface. Thus, the wiper generated a warp W of 4±1 mm (first amount of warp) during the wiping of the nozzle area.

In this state, the carriage was moved along the ink ejection surface at a speed of 100 mm/s in the wiping direction to wipe off ink adhering to the ink ejection surface. Then driving control in the embodiment described above first was performed, in which the wiper was stopped at a prescribed position. Specifically, ink adhering to the ink ejection surface was wiped off at a wiping speed of 100 mm/s. Then the wiper was stopped so that the distance D (see FIG. 20) fell within the range of −2 mm to +3 mm, the distance D being from the edge of the ink ejection surface on the downstream side, taken as the reference position (±0 mm), to the upstream edge of the wiper in a state in which the wiper was not warped.

The wiper was then moved away from the ink ejection surface at a speed of 2 mm/s. It was then visually checked whether an ink droplet remained on the ink ejection surface and ink scattered to a wall surface placed on the downstream side in the wiping direction. After the ink ejection surface was repeatedly wiped 20 times, it was also visually checked whether an ink droplet adhered to the side surface at the end of the recording head. Results are indicated in Table.

The carriage was also made to pass through the edge of the ink ejection surface without reducing the travel speed (wiping speed) of the carriage from 100 mm/s. Then the wiper was stopped (the distance D was +4 mm or longer). Results at this distance were also indicated in Table.

TABLE

| Distance D | Ink remaining on ink | | |
|---|---|---|---|
| (mm) | ejection surface | Scattered ink | Adhered ink |
| −2 | None | Presence | Presence |
| −1 | None | Presence | Presence |
| ±0 | Presence | Presence | Presence |
| +1 | Presence | Presence | Presence |
| +2 | Presence | Presence | Presence |
| +3 | Presence | Little | Little |
| +4 or more | Presence | None | None |

As clearly indicated from Table, when the distance D was less than ±0 mm, the upstream edge of the wiper stopped upstream of the downstream edge of the ink ejection surface. Therefore, when the wiper was moved away from the ink ejection surface and its warp was released, the top of the wiper did not completely wiped the ink ejection surface to its downstream edge, and ink remained on the ink ejection surface. When the wiper was moved away from the ink ejection surface and its warp was released with the distance D being greater than or equal to ±0 mm, the top of the wiper wiped the ink ejection surface to its downstream edge. Therefore ink did not remain on the ink ejection surface.

With the distance D being less than or equal to +3 mm, the amount of warp was gradually reduced from the first amount of warp during the movement of the wiper away from the ink ejection surface. Therefore, the scattering of ink was reduced. In addition, adhesion of an ink droplet to the side surface at the edge of the recording head was reduced. This was an unanticipated effect. Particularly, when the distance D was +2 mm or shorter, no ink scattering or ink droplet adhesion was found at all. A possible reason for this is that when the distance D is +2 mm or less, the amount of warp at the time when the wiper moves away from the ink ejection surface is less than or equal to the maximum amount of warp up to which ink does not scatter.

When the carriage was made to pass through the edge of the ink ejection surface without lowering the travel speed (wiping speed) of the carriage (the distance D was +4 mm or greater), the wiper passed through the downstream edge of the ink ejection surface while being warped by 4±1 mm. Therefore, ink adhering to the wall surface was found over a wide range on the wall. An ink droplet also adhered to the side surface at the edge of the recording head.

As described above, the structures in the embodiments of the present disclosure can be applied to an inkjet recording apparatus that performs recording by ejecting ink from recording heads. The structures in the embodiments of the present disclosure can be used to provide an inkjet recoding apparatus that, for example, can suppress the printing surface of a recording medium from being contaminated and can also efficiently suppress the interior of the apparatus from being contaminated by ink scattered from the wiper.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A wiping mechanism of a recording head, comprising:
a wiper configured to wipe an ink ejection surface of the recording head in a prescribed wiping direction, the recording head having an ejection nozzle from which to eject an ink;
a driving mechanism configured to move the wiper bidirectionally along the ink ejection surface and raise and lower the wiper toward and away from the ink ejection surface; and
after a top of the wiper passes through a nozzle area, which is part of the ink ejection surface, on which the ejection nozzle is open, and before the top of the wiper passes through an edge of the ink ejection surface on a downstream side in the wiping direction, the driving mechanism is configured to move the wiper away from the ink ejection surface with the top of the wiper in contact with the ink ejection surface so that, in comparison of a first amount of warp with a second amount of warp, the second amount of warp is kept less than the first amount of warp, the first amount of warp being an amount by which the wiper is warped in a direction in which the wiper moves when the top of the wiper passes through the nozzle area, the second amount of warp being an amount by which the wiper is warped when the top of the wiper passes through the edge on the downstream side of the ink ejection surface.

2. The wiping mechanism according to claim 1, wherein after the driving mechanism stops the wiper at a position at which a distance from the edge of the ink ejection surface on the downstream side in the wiping direction to an edge of the wiper on an upstream end in the wiping direction when the wiper is not warped does not exceed the first amount of warp, the driving mechanism moves the wiper away from the ink ejection surface.

3. The wiping mechanism according to claim 1, wherein the driving mechanism stops the wiper at a position at which the second amount of warp does not exceed a maximum amount of warp up to which an ink droplet adhering to the wiper does not scatter when a warp of the wiper is eliminated and the wiper is restored to an original shape of the wiper.

4. The wiping mechanism according to claim 1, wherein the driving mechanism moves the wiper away from the ink ejection surface while continuing to move the wiper in the wiping direction.

5. The wiping mechanism according to claim 1, wherein the wiper is brought into pressure contact outside the nozzle area when wiping starts.

6. The wiping mechanism according to claim 1, comprising a carriage, wherein:
a plurality of recording heads arranged in a recording medium transport direction or a direction orthogonal to the recording medium transport direction;
a plurality of wipers are secured to the carriage corresponding to the plurality of recording heads; and
the driving mechanism causes the plurality of wipers to concurrently wipe the ink ejection surfaces of the plurality of recording heads by moving the carriage bidirectionally and raising-and-lowering the carriage.

7. An inkjet recording apparatus comprising:
a recording head; and
a wiping mechanism including a wiper and a driving mechanism; wherein
the wiper is configured to wipe an ink ejection surface of the recording head in a prescribed wiping direction, the recording head having an ejection nozzle from which to eject an ink,
the driving mechanism is configured to move the wiper bidirectionally along the ink ejection surface and raises and lowers the wiper toward and away from the ink ejection surface, and
after a top of the wiper passes through a nozzle area, which is part of the ink ejection surface, on which the ejection nozzle is open, and before the top of the wiper passes through an edge of the ink ejection surface on a downstream side in the wiping direction, the driving mechanism is configured to move the wiper away from the ink ejection surface with the top of the wiper in contact with the ink ejection surface so that, in comparison of a first amount of warp with a second amount of warp, the second amount of warp is kept less than the first amount of warp, the first amount of warp being an amount by which the wiper is warped in a direction in which the wiper moves when the top of the wiper passes through the nozzle area, the second amount of warp being an amount by which the wiper is warped when the top of the wiper passes through the edge on the downstream side of the ink ejection surface.

8. The inkjet recording apparatus according to claim 7, wherein after the driving mechanism of the wiping mechanism stops the wiper at a position at which a distance from the edge of the ink ejection surface on the downstream side in the wiping direction to an upstream edge of the wiper in the wiping direction when the wiper is not warped does not exceed the first amount of warp, the driving mechanism moves the wiper away from the ink ejection surface.

9. The inkjet recording apparatus according to claim 7, wherein the driving mechanism of the wiping mechanism stops the wiper at a position at which the second amount of warp does not exceed a maximum amount of warp up to which an ink droplet adhering to the wiper does not scatter when a warp of the wiper is eliminated and the wiper is restored to an original shape of the wiper.

10. The inkjet recording apparatus according to claim 7, wherein the driving mechanism of the wiping mechanism moves the wiper away from the ink ejection surface while continuing to move the wiper in the wiping direction.

11. The inkjet recording apparatus according to claim 7, wherein the wiper of the wiping mechanism is brought into pressure contact outside the nozzle area when wiping starts.

12. The inkjet recording apparatus according to claim 7 comprising:
a recording medium transporting mechanism that transports a recording medium in a first direction;
the recording head ejects an ink to the recording medium, which is transported by the recording medium transporting mechanism, the recording head being one of a plurality of recording heads arranged in at least one row along the first direction;
the wiper is one of a plurality of wipers that are located in correspondence to the plurality of recording heads and wipe the ink ejection surfaces of the plurality of recording heads;
the wiping mechanism includes a carriage to which the plurality of wipers are secured and also includes a support frame that supports the carriage so that the carriage is bidirectionally movable;
the driving mechanism moves the carriage bidirectionally along the support frame and raises and lowers the support frame together with the carriage toward and away from the ink ejection surface; and
the wiping mechanism moves the carriage bidirectionally in a direction along the ink ejection surface and raises and lowers the carriage to have the wipers concurrently wipe the ink ejection surfaces of the plurality of recording heads.

13. The inkjet recording apparatus according to claim 12 further comprising:
a head housing that integrally holds the plurality of recording heads;
the carriage abuts the head housing when the support frame comes close to the ink ejection surface; and
the carriage has a positioning member that maintains a spacing between the plurality of wipers and the ink ejection surface at a prescribed distance.

14. The inkjet recording apparatus according to claim 13, wherein the positioning member is a driven rotating body that rotates in a direction in which the plurality of wipers move along the ink ejection surface.

15. The inkjet recording apparatus according to claim 12, wherein the driving mechanism of the wiping mechanism includes a lift member that is selectively placed in an extended state and a horizontal state by being rotated while in contact with a lower end of the support frame and also includes a shaft to which the lift member is secured, the shaft being rotatable together with the lift member.

16. The inkjet recording apparatus according to claim 15, wherein the driving mechanism includes a lifting roller that is rotatably supported at one end of the lift member, the lifting roller is urged by an urging member away from the shaft.

17. The inkjet recording apparatus according to claim 15, wherein:
the wiping mechanism is selectively located at a maintenance position close to the ink ejection surfaces of the plurality of recording heads and a standby position apart from the ink ejection surfaces;
the plurality of wipers are selectively located at a wiping position, at which when the wiping mechanism is located at the maintenance position, the recording heads come close to the ink ejection surfaces and a wiping is performed, and a distant position apart from the ink ejection surface;
when the lift member is placed in the extended state, the plurality of wipers are located at the wiping position; and
when the lift member is placed in the horizontal state, the plurality of wipers are located at the standby position.

18. The inkjet recording apparatus according to claim 12, wherein the carriage of the wiping mechanism moves bidirectionally in the first direction or a second direction orthogonal to the first direction.

19. The inkjet recording apparatus according to claim 12, wherein:
the support frame has a rectangular shape having two edges extending in the first direction and two edges extending in the second direction;
the driving mechanism includes a plurality of lift members, each of which is selectively placed in an extended state and a horizontal state by being rotated while in contact with a lower end of the support frame, and also includes a plurality of shafts, to each of which at least one of the plurality of lift members is secured, the shaft being rotatable together with the at least one of the plurality of the lift member;
each of the plurality of shafts is positioned so as to correspond to any one combination of two sides of the two edges extending in the first direction and the two edges extending in the second direction;
two or more lift members are located on each of the plurality of shafts; and
the two or more lift members have the same angle of inclination while the two or more lift members are being switched between the extended state and the horizontal state.

20. A method of wiping a recording head, comprising:
wiping a nozzle area, which is part of an ink ejection surface of the recording head having an ejection nozzle from which to eject an ink, on which the ejection nozzle is open, in a prescribed wiping direction by using a driving mechanism to move a wiper bidirectionally along the ink ejection surface and to raise and lower the wiper toward and away from the ink ejection surface; and
moving, after a top of the wiper passes through the nozzle area and before the top of the wiper passes through an edge of the ink ejection surface on a downstream side in the wiping direction, the wiper away from the ink ejection surface with the top of the wiper in contact with the ink ejection surface so that, in comparison of a first amount of warp with a second amount of warp, the second amount of warp is kept less than a first amount of warp, the first amount of warp being an amount by which the wiper is warped in a direction in which the wiper moves when the top of the wiper passes through the nozzle area, the second amount of warp being an amount by which the wiper is warped when the top of the wiper passes through the edge on the downstream side of the ink ejection surface.
